(19) United States
(12) Patent Application Publication
(10) Pub. No.: US 2015/0040237 A1
(43) Pub. Date: Feb. 5, 2015

(54) SYSTEMS AND METHODS FOR INTERACTIVE CREATION OF PRIVACY SAFE DOCUMENTS

(71) Applicant: XEROX CORPORATION, NORWALK, CT (US)

(72) Inventor: David R. Vandervort, Walworth, NY (US)

(73) Assignee: XEROX CORPORATION, NORWALK, CT (US)

(21) Appl. No.: 13/959,230

(22) Filed: Aug. 5, 2013

(51) Int. Cl. G06F 21/60

(52) U.S. Cl. CPC G06F 21/60
USPC 726/26

(57) ABSTRACT

Embodiments relate to systems and methods for interactive creation of privacy safe documents. In aspects, an online document processing system can be configured to include a text editor with a set of privacy controls. The text editor can interact with a remote privacy engine to scan an original document entered by a user, to seamlessly detect potentially sensitive data such as medical information contained in that document as it is entered. When potentially sensitive data is identified, for instance by checking the entered content, data fields or formats of a Web form, the privacy engine can generate text substitution data to transmit to the text editor. Potentially sensitive data, such as social security numbers or other personal or private identifiers, can therefore be masked redacted to export to Web sites, users or services without exposing potentially sensitive data.

### FIELD

The present teachings relate to systems and methods for interactive creation of privacy safe documents, and more particularly, to platforms and techniques for providing automatic detection and protection of documents containing potentially sensitive information entered into a Web form or other type of document.

### BACKGROUND

In known online document processing systems, a user may be presented with predefined forms and other kinds of documents interfaces, to enter information such as personal information, medical information, account data, transactional records, and other types of entries. In those types of platforms, there may be a need to request, receive and store relatively sensitive user information. That type of information can include, merely for example, the social security number or other personal identifier of the user, all types of medical information for the user, personal address or contact information of the user, or any other of a variety of comparatively sensitive or private pieces of information regarding a user, or other entity. In known online document processing systems, such as sites or services provided for medical processing or other types of systems, there is no ability to detect or protect different sensitive pieces of data as it is entered, and potentially before it is exported or transmitted to other users, platforms, or services.

It may be desirable to provide methods and systems for interactive creation of privacy safe documents, in which online document systems can scan for, detect, and protect documents containing potentially sensitive data automatically, to assist the user in secure data storage and export.

### DESCRIPTION OF DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall environment in which systems and methods for interactive creation of privacy safe documents can be implemented, according to various embodiments;

FIG. 2 illustrates an overall environment in which systems and methods for interactive creation of privacy safe documents can be implemented, according to various embodiments in further regards;

FIG. 3 illustrates a flowchart of data entry processing, according to various embodiments; and

FIG. 4 illustrates a diagram of hardware and other resources that can be used to support privacy processing in systems and methods for interactive creation of privacy safe documents, according to various embodiments.

### DESCRIPTION OF EMBODIMENTS

Embodiments of the present teachings relate to systems and methods for interactive creation of privacy safe documents. More particularly, embodiments relate to platforms and techniques for providing a service to identify potentially sensitive data that may be captured in an online document processing system. The platform can in aspects use a backend privacy engine to detect potentially sensitive information while it is being entered, in seamless fashion to the user. The user can be prompted to mask, redact or otherwise protect that type of data during construction of the document. Data items selected for protection can be protected at all future points in the document.

Once the entry process is completed, a privacy protected version of the original document can then be generated and prepared for export to other users, Web sites, or other destination for processing or storage.

Reference will now be made in detail to exemplary embodiments of the present teachings, which are illustrated in the accompanying drawings. Where possible the same reference numbers will be used throughout the drawings to refer to the same or like parts.

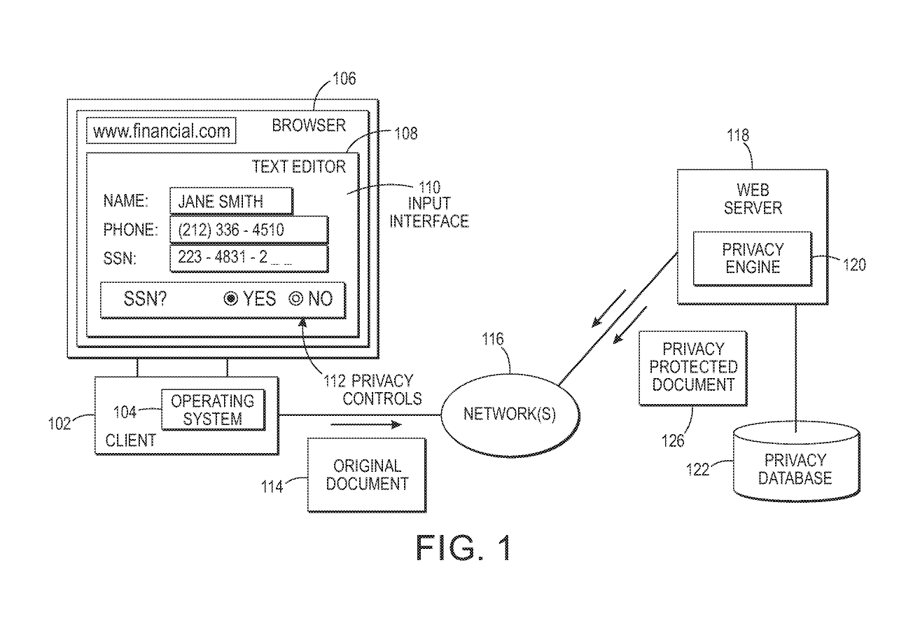

FIG. 1 illustrates an overall environment in which systems and methods for interactive creation of privacy safe documents can operate, according to aspects. In aspects a user can operate a client 102 connected to one or more networks 116, such as the Internet and/or other public or private networks. The client 102 can be configured with, and run under control of, an operating system 104 to execute programs and services, including, as shown a browser 106. The browser 106 can be operated to navigate to various locations in the Internet or other network, such as, merely for instance, a Web site supported by a Web server 118, dedicated to providing medical services, or any other services. Although the overall system shown in FIG. 1 is illustrated as involving a Web browser interacting with a Web server, it will be appreciated that other types of client-server architectures can be used, including those that do not involve or rely upon Web sites or Web browsers.

Upon navigating to the desired site supported by the Web server 118, the browser 106 or other client software can invoke a text editor 108 configured to interact with the Web server 118, to receive inputs related to the service provided by the Web site. In aspects as shown, the text editor 108 can include an input interface 110 to request and receive data from the user. The input interface 110 can in general be or include a graphical user interface, including for example text input boxes, buttons or other selection or input gadgets, and/or other interface elements to query the user for desired information, and receive character or other data entered by the user.

The user can interact with the input interface 110 to supply a set of character inputs to enter an original document 114. The original document 114 can contain information such as text, numbers, or other data which is transmitted to the Web server 118. The user input can, in implementations, be received in free-text form. The information can be decomposed by the privacy engine 120 into tokens, or symbolic elements, as the user enters their desired information. Tokens can include words, but also punctuation and other symbolic elements. The system can group those tokens for processing, including into bi-grams (two tokens) and/or n-grams (n tokens) which the privacy engine 120 and/or other logic can use to detect features such as compound expressions, for example a name consisting of a first name and last name.

In implementations, the browser 106 can incorporate logic or services to interact with the text editor 108, the Web server 118, and/or other entities, for instance using Java™ or other programming extensions. In further implementations, input operations can take place through various other types of software other than a browser, such as applications designed for mobile devices.

The text editor 108 invoked in connection with the corresponding Web site can also generate or present a set of privacy controls 112 which interact with the input interface 110 and the user input to manage and protect potentially sensitive information contained in the original document 114 supplied by the user to the text editor 108.

According to aspects, for instance, the user can operate the input text editor 108 to progressively enter the original document 114. The original document 114 can be stored locally on client 102, and/or be uploaded and stored to Web server 118. During creation of the original document 114, privacy protection operations can be initiated, for instance, by way of the user manually invoking the privacy protection operations or automatically under control of the input interface 110.

Upon initiating privacy protection, the privacy engine 120 can access the original document 114 and receive data being entered into that document for the presence of potentially sensitive information. The privacy engine 120 can for instance decompose and scan the information being entered into the original document 114 for tokens, bi-grams, n-grams, and other data, information, and/or fields involving medical identifiers, medical charts or history, prescription information, personal contact or identification information, and/or other sensitive information. The set of privacy controls 112 can cooperate with a privacy engine 120 of the Web server 118 to interact with the user during detection of that type of data in the original document 114. The privacy engine 120 can, in implementations, likewise detect the entry of potentially sensitive data by identifying a data field or format, such as a nine-digit numeric identifier suggesting the entry of a social security number. Other techniques for identifying the existence or type of potentially sensitive data contained in original document 114 as it is being composed can be used.

During the interactive scanning of the original document 114, the privacy engine 120 can access a privacy database 122 to match or correlate the data being entered to information in a privacy database 122, which may include predetermined data types, objects, formats, fields, and/or other structures that correspond to potentially sensitive data. Potentially sensitive data can include, besides medical information as noted above, other personal or private identifiers such as driver's license information, passport information or others. That data can likewise include any other type of data which can be of a sensitive, private, hidden, or confidential nature, including, for example, financial information, tax information, and/or other types or classes of data. For each desired data type, the privacy database 122 can store or record associated formats, fields, structures, identifiers, metadata, and/or other information that can be used to scan the content of the original document 114 as it is being received from the user. In the case of medical information, potentially sensitive information can be defined by or related to health care regulations such as HIPPA. The potentially sensitive information captured or identified for a given original document 114 can be stored by the privacy engine 120 in a list or dictionary for that document.

When a match to a piece of potentially sensitive data is determined by the privacy engine 120, the privacy engine 120 can respond by accessing, retrieving, and/or otherwise invoking the set of privacy controls 112. The privacy controls 112 can provide the user with prompts or options to identify various types of sensitive data, and apply protection to that data. For instance, the privacy controls 112 can provide the user with an option to generating text substitution data 124 to substitute, redact, mask, and/or otherwise protect the detected data field. When chosen or accepted, the text substitution data 124 can be transmitted to the browser 106, text editor 108, and/or other application.

The text substitution data 124 can as noted be or include redacted or altered versions of data of interest. In the case of a social security number, for instance, the original nine digits of the social security number can be redacted, masked, or substituted with a set of masking characters, such as “xxx-yyy-zzz,” or other symbols or representations that then appear within the corresponding sections of the page displayed by the text editor 108. It will be appreciated that other protection techniques for potentially sensitive data can be used.

It will also be appreciated that the process of redacting portions of the original document 114 using text substitution data 124 can take place in a fully interactive fashion, in real-time or substantially real-time as the user enters the original document 114 for privacy protection purposes. That is to say, the detection and protection operations are carried out in seamless or transparent fashion to the user, who can continue to enter data in the text editor 108 in accustomed fashion. The detection and protection operations are also carried out in a differential fashion, in that only newly entered data is processed, and words, phrases, and sentences which have already been processed are not analyzed again. Once marked as sensitive or requiring protection, a word, phrase, or sentence can automatically be processed the same way throughout the document.

In implementations, it may be noted that the privacy engine 120 can optionally incorporate a suggestion feature, by which a user who appears to begin entering private data of a recognized format or type can be presented with prompts or suggestions for the remaining characters or fields of that data, such as “abc-de-fghi” for social security entries, or others.

In further aspects, it may also be noted that the privacy controls 112 can include selections for the user to un-mask or otherwise remove the redaction of data or fields which have been selected or identified as sensitive data. Conversely, the privacy controls 112 can allow the user to select or identify data or fields which have not been identified by the privacy engine 120 as being potentially sensitive, as information which the user nonetheless wishes to select for protection in the original document 114. In implementations, for that document, the privacy engine 120 can then treat those user-identified expressions as representing potentially sensitive data which will then be subject to redaction or other protection.

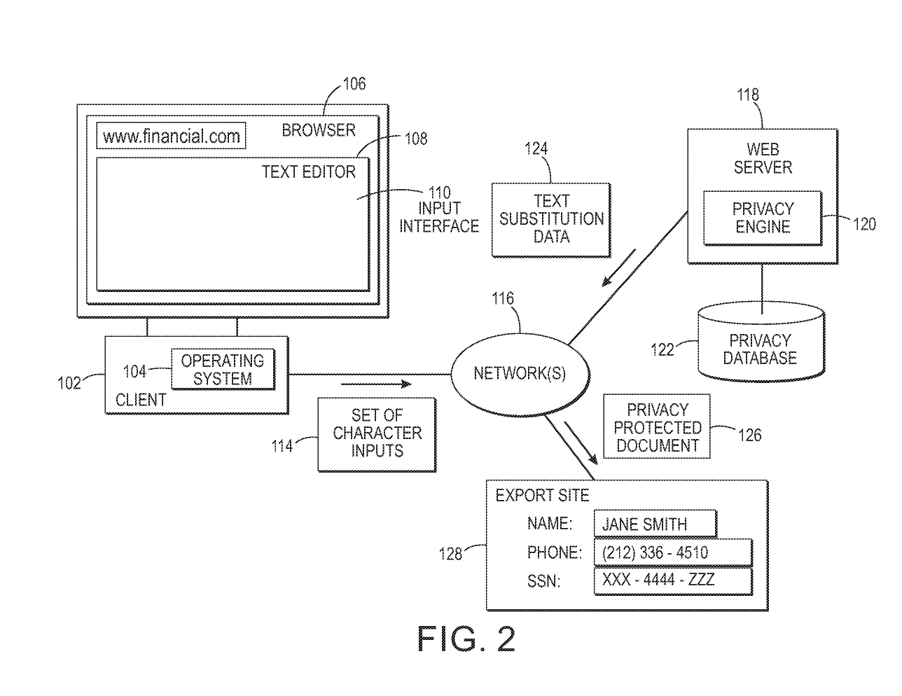

In implementations, once a user has completed the entry of the original document 114, the system can generate, using user selections or confirmations received via the privacy controls 110, a privacy protected document 126. The privacy engine 120 can cause the various redactions or protections to be applied only at completion of the original document 114, to cause the privacy protected document 126 to be generated, as a separate version of the document. The privacy protected document 126 can then be uploaded or stored the Web server 118 or other site, for export or other purposes. The privacy protected document 126 can then be transmitted or exported, as shown in FIG. 2, to one or more export site 128 and/or other destination, such as a user, application, or service which will receive the privacy protected document 126. The privacy engine 120 can store that document to the privacy database 122 and/or other data store, for instance in a portable document format. The export site 128 can be or include, for instance, the Web site of a hospital, insurance company, and/or other entity or organization, as well as a site, email address, and/or other destination associated with one or more other individual users. It may be noted that the original document 114 can also be stored locally or remotely, for further work by the user.

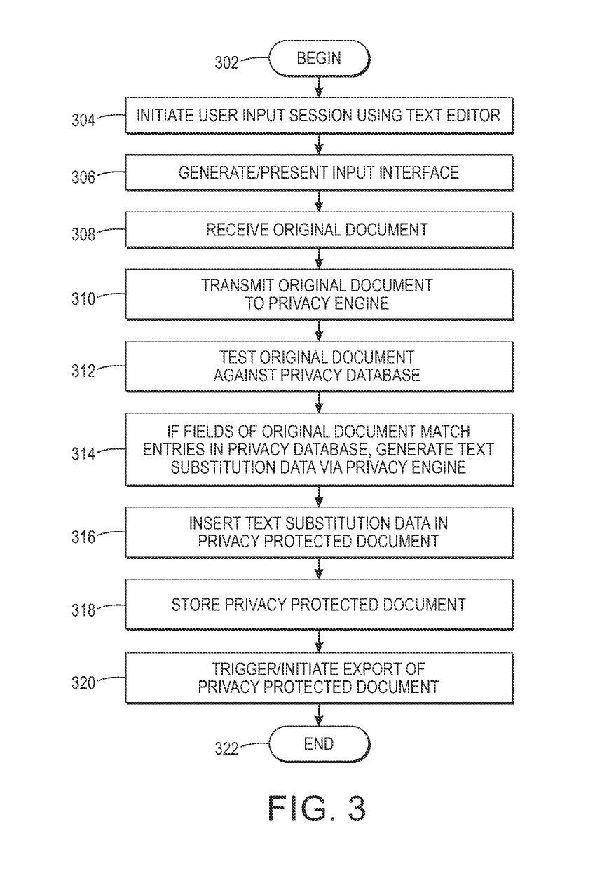

FIG. 3 illustrates a flowchart of data detection, privacy protection, and other processing that can be performed in systems and methods for interactive creation of privacy safe documents, according to aspects. In 302, processing can begin. In 304, a user input session can be initiated using the text editor 108, for instance, through navigating through the browser 106 to a Web site supported or operated by the Web server 118, or through other channels or services. In 306, the input interface 110 can be generated and/or presented in the text editor 108.

In 308, an original document 114 can be received via the text editor 108 and/or input interface 110. The original document 114 can contain textual or other data such as character inputs, alphanumeric inputs, symbolic inputs, and/or others types or formats of inputs. In 310, the text editor 108 and/or other logic or service can transmit the input stream being entered into the original document 114 to the Web server 118. In 312, the privacy engine 120 can scan or test the input stream of the original document 114 against the privacy database 122, to determine whether the original document 114 matches the word, phrase, sentence, bi-gram, n-gram, format, type, metadata, content and/or other signature of potentially sensitive data known to the privacy database 122.

In 314, if any one or more fields or other data objects in the original document 114 matches an entry or entries in the privacy database 122, the privacy engine 120 can, upon user selection, generate text substitution data 124 to redact, mask, encode, and/or otherwise protect the potentially sensitive original document 114, upon completion of that document. In 316, the privacy engine 120 can insert, replace, and/or display the text substitution data 124 in place of sensitive data fields or items in the original document 114, to generate the privacy protected document 126. In 318, the privacy engine 120 can store the privacy protected document 126. The privacy protected document 126 can for instance be stored to the privacy database 122, and/or other local or remote data store.

In 320, an export of the privacy protected document 126 can be triggered or initiated, for instance by the user selected an option to transmit or export that document to a desired site, user, service, and/or other destination. In 322, processing can repeat, return to a prior processing point, jump to a further processing point, or end.

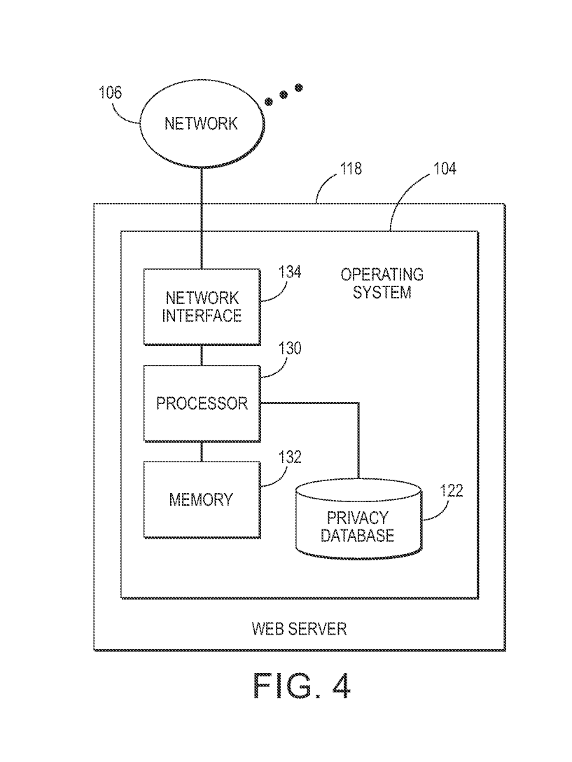

FIG. 4 illustrates various hardware, software, and other resources that can be used in implementations of interactive creation of privacy safe documents, according to embodiments. In embodiments as shown, the Web server 118 can comprise a platform including processor 130 communicating with memory 132, such as electronic random access memory, operating under control of or in conjunction with operating system 104. The processor 130 in embodiments can be incorporated in one or more servers, clusters, and/or other computers or hardware resources, and/or can be implemented using cloud-based resources. The operating system 104 can be, for example, a distribution of the Linux™ operating system, the Unix™ operating system, the Windows™ family of operating systems, or other open-source or proprietary operating system or platform. The processor 130 can communicate with the privacy database 122, such as a database stored on a local hard drive or drive array, to access or store the privacy protected document 126, and/or subsets of selections thereof, along with other content, media, or other data. The processor 130 can further communicate with a network interface 134, such as an Ethernet or wired or wireless data connection, which in turn communicates with the one or more networks 116, again such as the Internet or other public or private networks. The processor 130 can, in general, be programmed or configured to execute control logic and to control various processing operations, including to generate the text substitution data 124, privacy protected document 126, and/or other documents or data. In aspects, the privacy engine 120 and/or client 102 can be or include resources similar to those of the Web server 118, and/or can include additional or different hardware, software, and/or other resources. Other configurations of the Web server 118, the privacy engine 120, the client 102, associated network connections, and other hardware, software, and service resources are possible.

The foregoing description is illustrative, and variations in configuration and implementation may occur to persons skilled in the art. For example, while embodiments have been described in which one privacy engine 120 operates to control the privacy protection activities related to data entry via one text editor 108, in implementations, multiple privacy engines can cooperate to provide the same service to the text editor 108 and/or other application or service. Similarly, while the privacy engine 120 has been described in terms of being associated with one given Web server 118 (and/or Web site), in implementations, the privacy engine 120 can be associated with and support multiple Web servers (and/or Web sites). Other resources described as singular or integrated can in embodiments be plural or distributed, and resources described as multiple or distributed can in embodiments be combined. The scope of the present teachings is accordingly intended to be limited only by the following claims.

What is claimed is:

1. A method of encoding entered data, comprising:
receiving an original document from a user operating a text editor;
transmitting the original document to a privacy engine;
comparing information in the original document to data in a privacy database representing potentially sensitive data;
generating text substitution data based on the comparing; and
generating, under user control, a privacy protected document incorporating the text substitution data; and
storing the privacy protected document for export to a target destination.

2. The method of claim 1, wherein the text editor comprises a text editor operating in association with a browser.

3. The method of claim 2, wherein the browser communicates with a Web server operating a Web site.

4. The method of claim 3, wherein the Web site comprises a set of Web forms configured to query the user for a set of character inputs to generate the original document.

5. The method of claim 1, wherein the potentially sensitive data is identified by at least one of a format of the set of character inputs, a data field associated with the set of character inputs, or character content of the set of character inputs.

6. The method of claim 1, wherein the set of substitution data comprises a set of redacted symbols.

7. The method of claim 1, further comprising building a dictionary of potentially sensitive data for the original document.

8. The method of claim 1, further comprising exporting the privacy protected document to a target destination.

9. The method of claim 1, further comprising presenting a set of privacy controls to the user via the text editor to select privacy options

10. A system, comprising:
a network interface to a user operating a client; and
a processor, communicating with the client via the network interface, the processor being configured to—
receive an original document from a user operating a text editor running on the client,
transmit the original document to a privacy engine,
compare information in the original document to data in a privacy database representing potentially sensitive data,
generate text substitution data based on the comparing, generate, under user control, a privacy protected document incorporating the text substitution data, and
store the privacy protected document for export to a target destination.

11. The system of claim 10, wherein the text editor comprises a text editor operating in association with a browser.

12. The system of claim 11, wherein the browser communicates with a Web server operating a Web site.

13. The system of claim 12, wherein the Web site comprises a set of Web forms configured to query the user for the set of character inputs.

14. The system of claim 10, wherein the potentially sensitive data is identified by at least one of a format of the set of character inputs, a data field associated with the set of character inputs, or character content of the set of character inputs.

15. The system of claim 10, wherein the set of substitution data comprises a set of redacted symbols.

16. The system of claim 10, wherein the processor is further configured to build a dictionary of potentially sensitive data for the original document.

17. The system of claim 16, wherein the processor is further configured to export the privacy protected document to a target destination.

18. The system of claim 10, wherein the processor is further configured to present a set of privacy controls to the user via the text editor to select privacy options.
